(19) United States
(12) Patent Application Publication
(10) Pub. No.: US 2026/0298668 A1
(43) Pub. Date: Oct. 1, 2026

(54) COMPACT PRINTED CIRCUIT BOARD FOR AN INDUCTIVE SENSOR FOR MEASURING ANGULAR POSITION

(71) Applicant: VITESCO TECHNOLOGIES GmbH, Regensburg (DE)

(72) Inventors: Alain FONTANET, Toulouse (FR); Jérémie BLANC, Toulouse (FR)

(21) Appl. No.: 18/880,457

(22) PCT Filed: Aug. 21, 2023
(86) PCT No.: PCT/EP2023/072899

§ 371 Date: Dec. 31, 2024

(30) Foreign Application Priority Data
Aug. 26, 2022 (FR) FR2208543

(51) Int. Cl. G01D 5/20; G01B 7/30

(52) U.S. Cl. CPC G01D 5/20; G01B 7/30

(57) ABSTRACT

A printed circuit board for an inductive sensor intended for measuring the angular position of a target, the printed circuit board comprising:
at least two secondary windings (22a) each formed by at least one pair of poles (23), with each pair of poles extending along an arc of a circle equal to 360°/Nₜₒₜ, with Nₜₒₜ being an integer greater than or equal to 2; and
a primary winding (21), surrounding the secondary windings.

According to the invention:
each secondary winding (22a) comprises a number N₀ of pairs of poles, with 1≤N₀≤(Nₜₒₜ−1); and
the primary winding (21) delimits a surface of interest inscribed inside a disc, called useful disc, with a ratio between the area of the surface of interest and the area of the useful disc that ranges between 70% and 99%.

The invention is notably applicable in the automotive field, for measuring the angular position of an electric motor rotor. It makes it possible to offer optimal coupling between the windings and the target, while complying with major constraints in terms of available space for integrating the windings.

### TECHNICAL FIELD

The field of the invention is that of detecting the position of a moving mechanical structure, notably a rotor of a rotary machine, using a target securely mounted on said structure.

The invention more specifically relates to an inductive sensor configured to measure a position of a rotary part, notably, but not only, an axis of rotation or a rotor of a rotary electric machine.

### PRIOR ART

In a manner per se known, angular inductive sensors have a structure similar to that of linear inductive sensors: they comprise a fixed part, called “transformer”, and comprising a fixed primary winding and at least two fixed secondary windings, and a movable part formed by a metal target that is rigidly connected to the mechanical part to be angularly controlled.

The fixed primary winding and the fixed secondary windings are generally produced on a printed circuit board, and each form electrically conductive tracks traced on the printed circuit board.

The operating principle of such a sensor is based on the variation in coupling between the primary winding and the secondary windings, together forming a transformer operating at high frequency and without using a magnetic circuit. During use, currents induced in the target modify voltages induced in the secondary windings by the primary winding. In other words, the coupling between the primary and secondary windings varies as a function of the position of the target. By adapting the configuration of the windings and, if applicable, by knowing the current injected into the primary winding, measuring the voltage induced in the secondary windings allows the position of the target to be determined.

In a more detailed manner, during use, a high-frequency alternating current flows through the primary winding, producing a magnetic field at the same frequency.

Each secondary winding is surrounded by the primary winding, and forms at least two loops. The successive loops each surround a substantially identical surface. The successive loops intersect each other and therefore have an opposite orientation from a trigonometric perspective. Each secondary winding is formed by one or more pairs of these loops, with each pair of loops comprising two successive loops with opposite orientations. A pair of loops is referred to as a “pair of poles”, with one of the loops forming a positive pole and the other one of the loops forming a negative pole.

Due to the couplings between the primary winding and the loops of each secondary winding, the primary flow creates magnetic fluxes that are considered to be inverted from one loop to the next on each secondary circuit.

The primary and secondary windings are configured to be used with a metal target as mentioned above, which is rigidly connected to the mechanical part to be angularly controlled. The movement of the target modifies the coupling between the primary winding and each loop of each secondary winding.

In particular, the successive positions of the target in front of the loops of each secondary winding produce an amount of magnetic flux in these loops that varies as a function of time at the frequency of the current passing through the primary winding. A voltage therefore appears on the terminals of these secondary windings. The sign of this voltage depends on the direction of the loop. The algebraic sum of these voltages varies as a function of the movement of the target in front of these loops, following a curve that is fairly close to a sinusoid.

Measuring the voltage induced on the terminals of the secondary windings therefore allows the position of the mechanical part to be known.

When the inductive sensor is a sensor for measuring angular position, it is known for the primary and secondary windings to be arranged as a circle. An example of such a sensor is described, for example, in patent application US 2014/0167788 A1.

FIGS. 1A and 1B illustrate the windings of an inductive sensor for measuring angular position according to the prior art. The windings in this case comprise a primary winding and two secondary windings. For ease of understanding, FIG. 1A shows the primary winding and a first secondary winding, and FIG. 1B shows a second secondary winding.

The primary winding 11 is in the form of a circle, with an opening for inputting and outputting an electric current. It can be formed by several concentric circles, superimposed on various layers and/or faces of a printed circuit board. It surrounds the secondary windings 12a and 12b.

Each of the secondary windings 12a and 12b surrounds a disc-shaped surface with an open center, and has an opening for inputting and outputting an electric current. The secondary windings 12a and 12b are arranged concentrically with the primary winding 11.

Each of the secondary windings 12a and 12b is formed by at least one pair of poles 120, in this case two pairs of poles. Each pair of poles extends along an arc of a circle α, with α=360°/N, and N being an integer that is greater than or equal to the unit corresponding to the total number of pairs of poles in each secondary winding.

As mentioned above, each pair of poles 120 is formed by two loops, 121 and 122, with the same dimensions, oriented in opposite directions. The loops each can be formed by several turns, not shown, angularly offset with respect to one another in order to allow them to be produced on the same printed circuit board.

The two secondary windings 12a, 12b are substantially identical, and differ from one another only by a rotation by an angle β, with β=360°/(4*N).

The primary and secondary windings are generally integrated on the same printed circuit board, with an electronic component having a function for electrically powering the primary winding and/or a function for measuring voltage values across the terminals of the secondary windings.

This electronic component is generally disposed next to the windings, on the printed circuit board.

The distance between this electronic component and the windings must be high enough to avoid electromagnetic coupling between the windings and the electronic component during use. Furthermore, the manufacturing constraints require minimum spacing, in order to avoid damaging the electrical tracks forming the windings when integrating the electronic component.

This constraint sometimes involves having to reduce the size of the windings, which then extend along a disc with a reduced diameter in order to guarantee sufficient spacing relative to said electronic component. One disadvantage of this is that the coupling factor between the windings and the target is reduced, and may prove to be insufficient given any other constraints in terms of distance between the target and the windings (air gap).

An aim of the present invention is to propose a solution for overcoming the aforementioned disadvantages.

In particular, an aim of the invention is to propose a printed circuit board for an inductive sensor for measuring the angular position of a target, offering both optimal coupling with said target and optimal flexibility in terms of the spatial requirement.

### DISCLOSURE OF THE INVENTION

This aim is achieved with a printed circuit board for an inductive sensor intended for measuring the angular position of a target, the printed circuit board comprising:
at least two secondary windings each formed by at least one pair of poles, with each pair of poles extending along an arc of a circle equal to 360°/Nₜₒₜ, with Nₜₒₜ being an integer greater than or equal to 2; and
a primary winding, surrounding the secondary windings.

According to the invention:
each secondary winding comprises a number N₀ of pairs of poles, with 1≤N₀≤(Nₜₒₜ−1); and
the primary winding delimits a surface of interest inscribed inside a disc, called useful disc, with a ratio between the area of the surface of interest and the area of the useful disc that ranges between 70% and 99%.

As a variant, this ratio is greater than 80%, or even 90%, or even 95%. This ratio also can be less than 99%, or even 98%, or even 96%.

In other words, starting from the windings of an inductive sensor according to the prior art, and as illustrated in FIGS. 1A and 1B, one or even several pairs of poles is/are removed from the secondary windings, and the path followed by the secondary winding is adjusted in such a way as to be as close as possible to the shape of a disc, while passing at a distance from a determined obstacle.

The invention therefore allows both:
the windings to pass at a distance from a possible obstacle on the printed circuit board; and
the windings to extend in a shape close to that of a disc, with a disc diameter that is high enough to guarantee optimal coupling with the target, without having to reduce a distance between the target and the windings.

A compromise needs to be found between:
the proximity between the shape of the windings and a disc, with a disc shape providing rotational symmetry that makes the inductive sensor insensitive to any misalignment of the target (with the position measurement being an average of the responses of the plurality of pairs of poles of each of the windings); and
the diameter of a disc defining the shape of the windings, with the coupling factor with the target, and therefore the precision of the sensor, being higher the greater this diameter.

The disc defining the shape of the windings is called “useful disc”. According to the invention, the primary winding surrounds the secondary windings, and delimits a surface of interest inscribed inside this useful disc, with a ratio of areas as a % and ranging between 70% and 90% between the area of said surface of interest and the area of the useful disc.

The invention thus offers optimal coupling between the windings and the target, while being able to comply with mechanical integration constraints such as the presence of an electronic component in a determined location on the printed circuit board.

The invention is also extremely robust, with low sensitivity to misalignment between the windings and the target, by virtue of the shape of the windings being close to the shape of a disc. In this regard, it differs from alternative solutions, in which the secondary windings each comprise only a single pair of poles, with the primary winding exactly following the contour of the secondary windings.

The introduction mentioned the presence of an electronic component on the printed circuit board as an example of a mechanical constraint for integrating windings on the printed circuit board. It will be understood that the invention is not limited to this example and is applicable in numerous other situations in which the entire surface that is ideally preferred for the windings is not available.

The primary winding comprises at least one portion in the form of an arc of a circle, which can follow an external contour of the secondary windings, and at least one line connecting two ends of the at least one portion in the form of an arc of a circle. Furthermore, according to the invention, the surface of interest delimited by the primary winding passes through the center of the useful disc. Thus, the primary winding follows an external contour of the secondary windings, but passes at a distance from an internal contour of the secondary coils.

The diameter of the useful disc is advantageously less than or equal to 30 mm.

Advantageously, the primary winding comprises at least one portion in the form of an arc of a circle, which follows the periphery of the secondary windings.

The primary winding can further comprise at least one straight portion connecting together two ends of said portion in the form of an arc of a circle.

Preferably, the secondary windings extend together along an arc of a circle ranging between 200° and 340°.

The number No of pairs of poles is advantageously greater than or equal to 2.

The at least two pairs of poles can be arranged directly one after the other. The primary winding then can be formed by:
a portion in the form of an arc of a circle; and
a straight portion connecting together the ends of the portion in the form of an arc of a circle.

According to an advantageous variant, the number N₀ of pairs of poles is a multiple of 2, and the pairs of poles are distributed in two groups spaced apart from each other. The two groups are advantageously arranged in rotational symmetry, with an angle of rotation of 180°. The primary winding then can be formed by:
two portions in the form of an arc of a circle; and
two straight portions connecting the ends of the portions in the form of an arc of a circle in pairs.

The printed circuit board according to the invention can further comprise electronics having a function for electrically powering the primary winding and/or a function for measuring voltage values across the terminals of the secondary windings, with said electronics being arranged outside the primary winding and at least partly inside the useful disc.

### DESCRIPTION OF THE FIGURES

Further features and advantages of the invention will become more apparent upon reading the following description. This description is purely illustrative and should be read with reference to the appended drawings, in which:

FIG. 1A; and

FIG. 1B illustrate the windings of an inductive sensor for measuring angular position, according to the prior art;

FIG. 2A; and

FIG. 2B illustrate the windings of a printed circuit board for an inductive sensor for measuring angular position, according to a first embodiment of the invention;

FIG. 3 schematically illustrates the surface of interest according to the invention and the useful disc according to the invention;

FIG. 4 schematically illustrates the windings of a printed circuit board according to the invention, in use with a corresponding target;

FIG. 5A; and

FIG. 5B illustrate the windings of a printed circuit board for an inductive sensor for measuring angular position, according to a variant of the first embodiment of the invention;

FIG. 6 illustrates the primary winding and one of the secondary windings of a printed circuit board for an inductive sensor for measuring angular position, according to a second embodiment of the invention; and

FIG. 7 illustrates a printed circuit board according to the invention, further comprising an electronic component occupying a portion of a disc defining the shape of the windings.

### DETAILED DESCRIPTION OF AT LEAST ONE EMBODIMENT

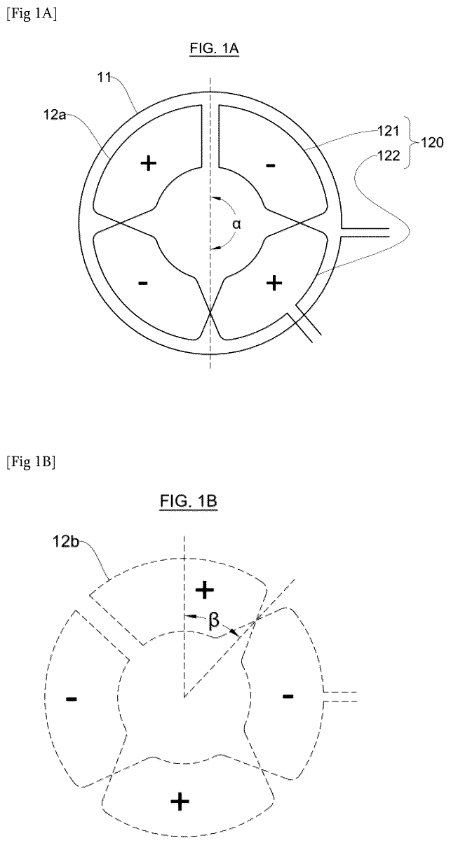

In order to better understand the invention, FIGS. 1A to 6 show only the windings, which are formed by metal tracks formed on a printed circuit board. The metal tracks can extend along the two opposite faces of the printed circuit board, with vias locally passing through the printed circuit board in the thickness direction. As a variant, the metal tracks can also extend into intermediate layers of a multilayer printed circuit board.

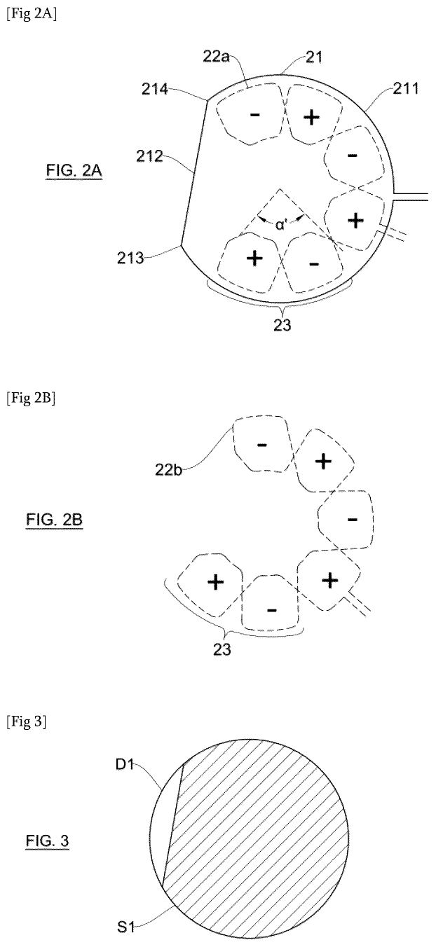

The windings of a printed circuit board according to the invention will be initially described with reference to FIGS. 2A and 2B. FIG. 2A illustrates the primary winding 21 and a first secondary winding 22a. FIG. 2B illustrates a second secondary winding 22b.

FIGS. 2A and 2B will only be described in terms of their differences relative to the windings of FIGS. 1A and 1B.

In FIGS. 2A and 2B, the windings are depicted as a top view, in a plane parallel to the plane of the printed circuit board.

Each secondary winding 22a, 22b is formed by at least one pair of poles 23, with each pair of poles 23 extending along an arc of a circle α′ equal to 360°/Nₜₒₜ, with Nₜₒₜ being an integer greater than or equal to 2. In this case, Nₜₒₜ=4.

In FIGS. 2A and 2B, the pairs of poles 23 are depicted schematically, and each comprise a loop oriented in a first direction, symbolized by the “+” sign, and a loop oriented in the opposite direction, symbolized by the “−” sign. For the sake of the legibility of the figures, the details of the turns forming each of the loops has not been depicted, with said turns being able to be distributed over one or more layers, and this aspect being an element known from the prior art and not forming the core of the invention.

Each secondary winding 22a, 22b comprises a number N₀ of pairs of poles 23, with 1≤N₀≤(Nₜₒₜ−1). In this case, N₀=3.

The two secondary windings 22a and 22b are substantially identical, and differ from one another only by a rotation by an angle B′, with B′=360°/(4*Nₜₒₜ).

The two secondary windings 22a and 22b are surrounded by the primary winding 21.

The primary winding 21 has a portion 211, in the form of an arc of a circle, and a line 212 located at the location of the at least one pair of missing poles and that connects the two ends 213 and 214 of the portion 211 in the form of an arc of a circle.

The primary winding 21 can be formed by a plurality of concentric turns distributed over one or more layers. Once again, for the sake of legibility, each of these turns has not been depicted separately.

In this case, the line 212 is a straight line. In variants that are not shown, the two ends 213 and 214 are connected by a curved line, or any other non-straight trace forming an open line. In any case, the line 212 is configured to bypass a predetermined obstacle.

The portion 211 in the form of an arc of a circle in this case extends at an angle ranging between 270° and 330°, following the external contour of the secondary windings 22a and 22b.

In any case, the primary winding delimits a surface of interest S1 (see FIG. 3, hatched area), inscribed inside a disc, called useful disc D1. In this case, the surface of interest S1 assumes the shape of a truncated disc, with the same diameter as the useful disc D1.

A ratio between the area of the surface of interest S1 and the area of the useful disc D1 ranges between 70% and 99%, in this case of the order of 98%.

Furthermore, advantageously, the surface of interest S1 passes through the center of the useful disc D1. This ensures that the shape of the surface of interest S1 does not excessively deviate from the shape of the useful disc D1.

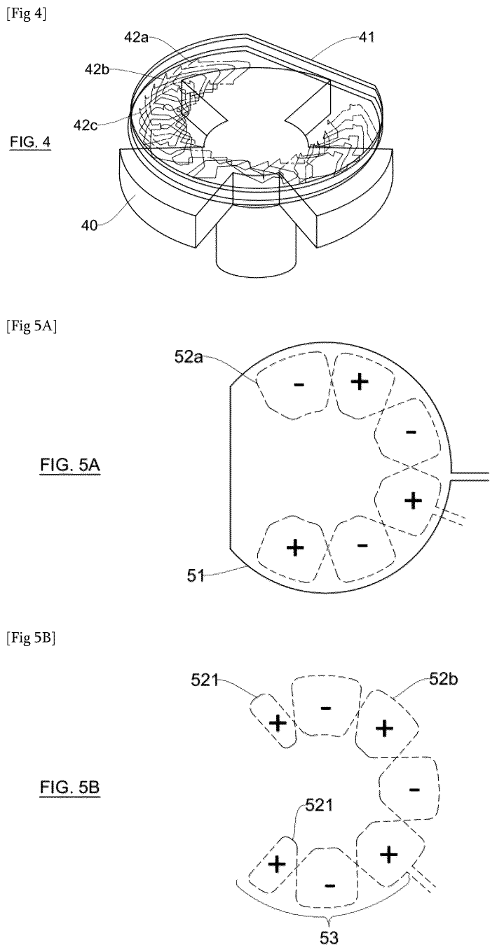

FIG. 4 schematically illustrates, as a perspective view, the windings of a printed circuit board according to the invention, in use with a corresponding target 40.

The target 40 is a metal target, arranged so as to be secured to a freely rotating mechanical element, the angular position of which is to be measured.

The target 40 comprises a plurality of blades arranged in a generally circular shape. In particular, the number of blades is equal to Nₜₒₜ, as defined above. In this case, there are therefore four blades. Each blade extends over an angular sector with the same extent, and the angular distribution of the blades is uniform.

The target 40 is concentrically arranged with the useful disc as defined above.

The target 40 is identical to the target intended to cooperate with a printed circuit board according to the prior art, comprising a number Nₜₒₜ of pairs of poles.

In the embodiment of FIG. 4, the windings of the printed circuit board comprise:
a primary winding 41, in this case formed by four turns: two concentric turns located on a first face of the printed circuit board, superimposed on two other concentric turns located on an opposite face of the printed circuit board; and
three secondary windings 42a, 42b, 42c, each made up of a plurality of turns that each extend over the first face and over the opposite face of the printed circuit board, with each secondary winding comprising two pairs of poles, with each pair of poles extending over an angle of 120°.

FIGS. 5A and 5B illustrate the windings of a printed circuit board for an inductive sensor for measuring angular position, according to a variant of the first embodiment of the invention. FIG. 5A illustrates the primary winding 51 and a first secondary winding 52a. FIG. 5B illustrates a second secondary winding 52b.

In this case, in order to reduce the total spatial requirement of the secondary windings 52a and 52b, the second secondary winding 52b comprises, at the ends thereof, two half-loops 521 with the same orientation. Thus, a surface occupied by the first secondary winding 52a is exactly superimposed with a surface occupied by the second secondary winding 52b, despite the angular offset between their respective pairs of poles. A pair of poles 53 can be defined on the second secondary winding as a whole loop and two half-loops located on either side of the whole loop.

In the variants described above, in each secondary winding the pairs of poles are arranged one directly after the other.

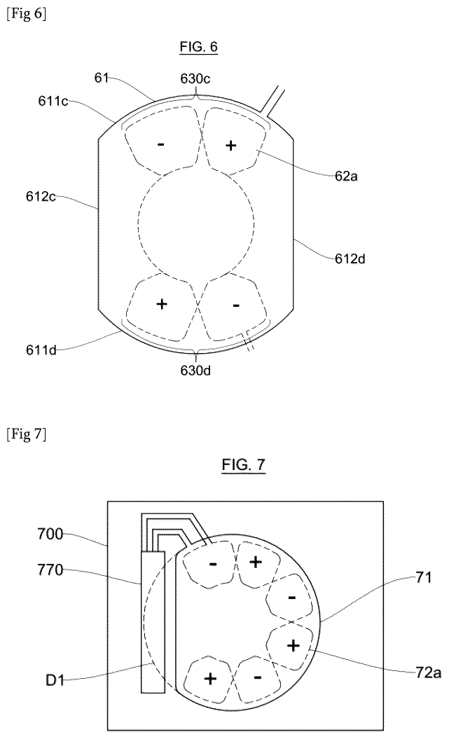

FIG. 6 illustrates the primary winding 61 and one of the secondary windings 62a of a printed circuit board for an inductive sensor for measuring angular position, according to a second embodiment of the invention.

This embodiment will only be described in terms of its differences relative to the embodiment of FIGS. 2A and 2B.

In this embodiment, the number N₀ of pairs of poles in each of the secondary windings is a multiple of two. In each secondary winding, the pairs of poles are distributed into two groups 630c, 630d. Each group 630c, 630d comprises the same number of pairs of poles. In this case, but in a non-limiting manner, each group 630c, 630d comprises a single pair of poles.

In each of the secondary windings, the two groups 630c, 630d are arranged spaced apart from each other. In this case, and advantageously, they are symmetrical to each other, following a rotational symmetry with an angle of 180°. By design this symmetry offers at least partial compensation of any mechanical offsets during integration (notably between the windings and the target).

The respective groups 630c, 630d of the plurality of secondary windings are superimposed on one another in order to form two blocks of turns.

The primary winding 61 surrounds the plurality of secondary windings. The primary winding 61 has:
a first portion 611c, in the form of an arc of a circle, which follows the contour of one of the first of said blocks of turns;
a second portion 611d, in the form of an arc of a circle, which follows the contour of the other one of said blocks of turns;
a first line 612c, connecting two ends, respectively, of the first portion 611c in the form of an arc of a circle and of the second portion 611d in the form of an arc of a circle; and
a second line 612d, connecting two other ends, respectively, of the first portion 611c in the form of an arc of a circle and of the second portion 611d in the form of an arc of a circle.

In this case, the first and second lines 612c, 612d are each straight. In variants that are not shown, these can be curved lines, or any other non-straight trace forming an open line. The first and second lines are not necessarily similar, one may be straight and the other may not be straight.

In this embodiment, the secondary windings 62a extend together along a cumulative arc of a circle ranging between 200° and 340°.

Finally, FIG. 7 illustrates a printed circuit board 700 according to the invention.

The printed circuit board 700 comprises:
a substrate 701 for receiving the primary and secondary windings, which substrate comprises at least one electrically insulating layer, the two opposite faces of which are covered with metal tracks; and
primary 71 and secondary 72a windings such as those described above (a single secondary winding 72a is depicted in FIG. 7, for the sake of the legibility of the figure).

In the embodiment of FIG. 7, the printed circuit board 700 further comprises an electronic component 770 having a function for electrically powering the primary winding 71 and a function for measuring voltage values across the terminals of the secondary windings 72a.

The electronic component 770 comprises, for example, at least one microcontroller.

The electronic component 770 extends close to the primary winding 71, outside the surface of interest delimited by said primary winding, and partly inside the useful disc D1, as defined with reference to FIG. 3.

By virtue of the invention, the primary winding 71 remains at a sufficient distance from the electronic component 770, without having to move the electronic component 770 (which would increase an overall spatial requirement of the printed circuit board), and also without having to reduce a diameter of a disc defining the shape of the windings. As explained in the introduction, this large diameter allows high coupling to be maintained between these windings and the target.

The invention is not limited to the examples and variants described above. The various examples and variants can be combined with one another. There can be two, three, or even more secondary windings. The secondary windings can each comprise several pairs of poles, or even a single pair of poles.

Advantageously, the diameter of the useful disc D1 (FIG. 3), defining the shape of the windings, is less than or equal to 50 mm, or even less than or equal to 30 mm. For these diameters, the inductive coupling is high between the primary winding and the secondary windings, as well as between the windings and the target. It is therefore possible to locally distance the primary winding relative to the secondary windings, with no adverse effect on the performance capabilities of the sensor. It is also possible to move the target away from the windings, in order to facilitate mechanical production.

Advantageously, the invention is applicable in the automotive field, notably for measuring the angular position of an electric motor rotor. The printed circuit board according to the invention is advantageously configured to be placed at one end of a rotation shaft. In a less preferred variant, the printed circuit board according to the invention can be configured to be traversed by the rotation shaft. In any case, it differs from printed circuit boards intended to be placed on the periphery of the rotation shaft, at a distance from the axis of rotation of the shaft.

The invention is particularly advantageous for adapting an inductive sensor on a pre-existing printed circuit board, on which the space available for the windings is stipulated. The invention particularly allows optimal coupling to be provided between the windings and the target as mentioned above, while complying with major constraints in terms of available space for integrating the windings.

Preferably, each pair of poles extending along an arc of a circle equal to 360°/Nₜₒₜ, and each secondary winding comprises a number N₀ of pairs of poles, with N₀=Nₜₒₜ−1 or N₀=Nₜₒₜ−2.

1. A printed circuit board (700) for an inductive sensor intended for measuring the angular position of a target, the printed circuit board (700) comprising:
at least two secondary windings (22a, 22b; 42, 42b, 42c; 52a, 52b; 62a; 72a) each formed by at least one pair of loops, called pair of poles (23; 53), with said loops surrounding respective surfaces with the same dimensions while being oriented in opposite directions and each being made up of one or more turns, and each pair of poles extending along an arc of a circle equal to 360°/Nₜₒₜ, with Nₜₒₜ being an integer greater than or equal to 2; and
a primary winding (21; 41; 51; 61; 71), surrounding the secondary windings;
wherein:
each secondary winding (22a; 22b; 42; 42b; 42c; 52a; 52b; 62a; 72a) comprises a number N₀ of pairs of poles, with 1≤N₀≤(Nₜₒₜ−1); characterized in that the primary winding (21; 41; 51; 61; 71):
has at least one portion (211; 611c, 611d) in the form of an arc of a circle and at least one line (212; 612c, 612d) that connects two ends (213, 214) of the at least one portion in the form of an arc of a circle; and
delimits a surface of interest (S1) inscribed inside a disc, called useful disc (D1), with a ratio between the area of the surface of interest and the area of the useful disc that ranges between 70% and 99%, with the surface of interest (S1) passing through the center of the useful disc (D1).

2. The printed circuit board (700) as claimed in claim 1, wherein the diameter of the useful disc (D1) is less than or equal to 30 mm.

3. The printed circuit board (700) as claimed in claim 1, wherein the at least one portion (211; 611c, 611d) in the form of an arc of a circle follows the periphery of the secondary windings.

4. The printed circuit board (700) as claimed in claim 3, wherein the at least one line (212; 612c, 612d) that connects two ends (213, 214) of a portion in the form of an arc of a circle is a straight portion (212; 612c, 612d) of the primary winding (21; 41; 51; 61; 71).

5. The printed circuit board (700) as claimed in claim 1, wherein the secondary windings (22a, 22b; 42, 42b, 42c; 52a, 52b; 62a; 72a) extend together in an arc of a circle ranging between 200° and 340°.

6. The printed circuit board (700) as claimed in claim 1, wherein the number N₀ of pairs of poles is greater than or equal to 2.

7. The printed circuit board (700) as claimed in claim 6, wherein the at least two pairs of poles (23; 53) are arranged directly one after the other.

8. The printed circuit board (700) as claimed in claim 7, wherein the primary winding (21; 41; 51; 71) is formed by:
a portion (211) in the form of an arc of a circle; and
a straight portion (212) connecting together the ends (213, 214) of the portion in the form of an arc of a circle.

9. The printed circuit board as claimed in claim 6, wherein the number N₀ of pairs of poles is a multiple of 2, and the pairs of poles are distributed into two groups (630c, 630d) spaced apart from each other.

10. The printed circuit board as claimed in claim 9, wherein the two groups (630c, 630d) are arranged in rotational symmetry, with an angle of rotation of 180°.

11. The printed circuit board as claimed in claim 9, wherein the primary winding (61) is formed by:
two portions (611c, 611d) in the form of an arc of a circle; and
two straight portions (612c, 612d) connecting the ends of the portions in the form of an arc of a circle in pairs.

12. The printed circuit board (700) as claimed in claim 1, further comprising electronics (770) having a function for electrically powering the primary winding (71) and/or a function for measuring voltage values across the terminals of the secondary windings (72a), with said electronics (770) being arranged outside the primary winding (71) and at least partly inside the useful disc.
